(19) United States
(12) Patent Application Publication
(10) Pub. No.: US 2003/0192851 A1
(43) Pub. Date: Oct. 16, 2003

(54) Nipple assembly for retrofit bottle attachment

(76) Inventor: Scott W. Ziegler, El Cajon, CA (US)

Correspondence Address: STETINA BRUNDA GARRED & BRUCKER, 75 ENTERPRISE, SUITE 250, ALISO VIEJO, CA, 92656, US

(21) Appl. No.: 10/390,198

(22) Filed: Mar. 17, 2003

Related U.S. Application Data
(60) Provisional application No. 60/371,453, filed on Apr. 10, 2002.

(51) Int. Cl. A61J 9/04; A61J 11/02

(52) U.S. Cl. 215/11.5

(57) ABSTRACT

A nipple assembly is provided for a water bottle. The tamper-evident cap from a bottle is removed and replaced with a nipple cap that has an opening through which a nipple extends. The nipple has a flange that is urged against an end wall of the nipple cap by a lip of the bottle. An annular disc is preferably interposed between the lip and the nipple flange with the disc being fastened to the nipple cap to prevent separation of the nipple from the nipple cap. A small channel in the disc places the inside of the bottle in gaseous communication with threads on the cap and thus in communication with the air. The channel is small enough to prevent fluid from leaking from the bottle.

### CROSS-REFERENCE TO RELATED APPLICATION

This application claims the benefit of U.S. Provisional Application No. 60/371,453, filed Apr. 10, 2002, the entire content of which is hereby incorporated by reference.

### FIELD OF THE INVENTION

The present invention relates generally to nipples for baby bottles, and more particularly to a nipple assembly which is specifically sized and configured for retrofit attachment to the externally threaded neck of a container or beverage bottle.

### BACKGROUND OF THE INVENTION

As is well known to most parents, baby bottle assemblies are often used as the means by which fluids such as juices and water are provided to an infant. Included in the baby bottle assembly is a nipple subassembly which includes an internally threaded collar having a central opening formed therein. In addition to the collar, the nipple subassembly includes a nipple having a main body portion and a circularly configured flange portion which extends radially outward from one end of the main body portion. The nipple subassembly is put together by advancing the main body portion of the nipple through the opening within the collar such that the flange portion of the nipple is brought into direct, abutting contact with the collar. The nipple subassembly, and in particular the collar thereof, is threadably engageable to a container of the baby bottle assembly.

The container itself defines an externally threaded neck, with the collar of the nipple subassembly being threadably engageable to the neck such that the flange portion of the nipple is captured and compressed between the collar and the distal rim defined by the neck of the container. In conventional baby bottle assemblies, the neck of the container has a relatively large diameter, thus defining a large opening into the interior of the container. As a result, the collar of the nipple assembly has a complementary, relatively large diameter.

Bottled water and juices as currently available in the marketplace are typically provided in bottles having an externally threaded neck with a diameter which is substantially less than that of the container of a baby bottle assembly, and a thread pattern which varies from that of the baby bottle assembly container. As a result, the nipple subassembly of a conventional baby bottle assembly would not be threadably engageable to the neck of such water bottle or juice bottle.

In many instances, it would be desirable for a parent to be able to simply attach the nipple subassembly directly to the water bottle or juice bottle. However, due to the diameter and thread configuration disparities described above, the parent must typically open the water bottle or juice bottle, and thereafter pour the contents thereof into the interior of the container of the baby bottle assembly. The large diameter neck on the bottle makes this fluid transfer between containers easier, but as will be recognized, such transfer creates a susceptibility to accidental spillage, particularly when such transfer is attempted in an environment such as a moving automobile. There is thus a need for an improved baby bottle and for an improved nipple assembly.

### SUMMARY OF THE INVENTION

The present invention addresses the above, and other problems by providing a nipple assembly which is specifically sized and configured for retrofit attachment to a conventional water bottle or juice bottle. This avoids the need to transfer fluid from one container to the baby bottle. Moreover, it reduces cleaning difficulties.

The openings on baby bottles are about the same diameter as the diameter of the bottle, or slightly smaller. The larger diameter opening on baby bottles makes it easier to gain access to the inside of the bottle and thus makes it easier to clean the bottle. The smaller neck of the conventional water and juice bottles do not allow easy access to the interior of the bottle, and do not allow easy cleaning of the bottle. But the need to clean and reuse water bottles and juice bottles is greatly diminished because they are typically discarded after the contents are consumed. Thus, while the small diameter coupling teaches against the conventional wisdom of having a large opening to allow easier cleaning of the baby bottle, the present invention takes advantage of this previously unappreciated and underutilized disposability to achieve the advantages described herein.

There is thus advantageously provided a nipple assembly for use with a bottle having a cylindrical portion with external threads and an external diameter of about 1.3 inches or less. That is the size commonly used for the water and fruit juice bottles. The cylindrical portion has a distal end that defines an opening to the bottle. A cap is provided that has an annular wall with internal threads sized to threadingly engage the threads on the bottle. The cap has an end wall connected to the annular wall, and the end wall has a central opening therein. A nipple extends through the opening in the cap. The nipple has an elongated portion sized to extend through the opening and also has an annular flange extending from a base of the nipple. The nipple has a distal end with an outflow opening therein. The nipple is advantageously, but optionally, made of a flexible material and being fastened to the cap. The assembly can be placed onto the threaded portion of the bottle to provide a nipple for a child to use.

Advantageously, but optionally, the nipple assembly further includes an annular snap ring abutting the flange and cooperating with a recess in the cap to fasten the nipple to the cap. The snap ring preferably, but optionally comprises a flat, annular ring having an inner and outer periphery defining a width greater than a thickness of the ring. The outer periphery cooperates with a groove in the cap to fasten the nipple to the cap. Advantageously, but optionally, the snap ring has an inner periphery and an outer periphery defining a width between the inner and outer peripheries, and at least one channel extending from the outer periphery toward the inner periphery a distance sufficient to extend past the distal end defining the opening of the bottle when the cap is placed on the bottle during use. The channel is preferably, but optionally sized to allow passage of air into the bottle but not allow water to pass out of the bottle when the cap is placed on the bottle. Advantageously, the channel does not extend to the inner periphery.

In a further variation, the nipple assembly has at least one handle extending from the cap a distance sufficient for a child to grab the handle while sucking on the nipple during use of the assembly. Advantageously the handle extends along a length of the bottle corresponding to about ½ to ¾ the length of the bottle.

In a further embodiment, the nipple assembly includes a cap having rotational locking means sized and configured to releasably engage the threads on the bottle during use. The cap has a opening with a nipple extending through the opening. The nipple is made of a flexible material and is fastened to the cap. The nipple and cap are sized to fit the bottles described above and hereinafter.

Advantageously, the nipple of this second embodiment comprises a flange larger than the opening, with the flange having a first surface abutting the cap and having an opposing, second surface abutting a flat disc having an inner and outer periphery defining a width. The width is large enough to engage the distal end defining the opening of the bottle during use. Advantageously, but optionally, the outer periphery of the flat disc cooperates with a ledge on the cap to permanently fasten the nipple to the cap. Advantageously, but optionally, the assembly also includes a channel extending across at least a portion of the width from the outer periphery toward the inner periphery, the channel having a width of about 0.005 inches or less. There is also preferably provided handle means fastened to the cap for holding the cap and bottle during use.

In a still further embodiment, the nipple assembly includes a nipple having a flange extending from a base of the nipple where the flange has a maximum dimension of less than about 1.3 inches. The nipple has a body portion extending from the flange and has an outflow opening in a distal end of the body portion. The nipple extends through a cap.

The cap has an opening therein through which the body portion extends, with the flange of the nipple abutting an end wall of the cap. The cap has side walls sized to accommodate the flange internal to the cap with internal threads being formed on the side walls. The nipple is fastened to the cap to prevent separation of the cap and nipple.

The cap fastens to a bottle that has a tubular, cylindrical portion with external threads and defining an opening to the bottle. A distal end of the cylindrical portion urges the flange against the end wall when the external threads threadingly engage the internal threads a sufficient amount.

Preferably, but optionally, an annular disc is interposed between the distal end of the cylindrical portion and the flange of the nipple. Preferably, but optionally, the annular disc is fastened to the cap to prevent removal of the nipple from the cap. Preferably, but optionally, there is at least one handle fastened to the cap. Advantageously, there are two handles, each extending along a length of the bottle a distance of about ½ to ¾ of a length of the bottle. Preferably, the handles are integrally molded with the cap. Ideally, the bottle comprises a bottle of water purchased full and with a sealed cap which sealed cap is removed and discarded so the nipple assembly can be fastened to the bottle. Ideally, a channel is formed on a side of the disc facing the bottle, the channel being sized to place the interior of the bottle in gaseous communication with the threads on the side walls but to prevent liquid from flowing from the bottle and through the channel during use of the nipple assembly. That helps prevent creating a vacuum in the bottle that collapses the nipple and disrupts a baby's drinking from the nipple.

The invention also includes a method of providing fluids to a child. The method includes removing a tamper-evident cap from a bottle of fluid, the bottle having a tubular outlet with a distal end and external threads that threadingly engage the tamper-evident cap to provide a fluid tight seal over the outlet prior to removal of the tamper-evident cap. If the bottle is pre-used, the tamper evident cap will have been removed previously and the bottle filled by the user. The method then fastens a nipple assembly to the bottle by threadingly engaging internal threads on a nipple cap to advance an end wall of the nipple cap toward the bottle until the distal end of the tubular outlet urges a flange of a nipple toward the end wall of the nipple cap an amount sufficient to form a fluid tight seal with the nipple cap. The nipple extends through an opening in the nipple cap and has a outflow opening in a distal end of the nipple to allow the child to suck fluid from the bottle and through the outflow opening.

The method also preferably, but optionally includes fastening the nipple to the nipple cap to prevent separation of the nipple from the cap. Further, the method preferably, but optionally, includes interposing an annular disc between the distal end of the outlet and the flange of the nipple and fastening the disc to the nipple cap to prevent separation of the nipple from the nipple cap. The method preferably also includes forming a channel in the annular disc, the channel extending in a direction from an outer periphery toward an inner periphery of the disc, with the channel being sized to allow air to pass into the bottle while preventing fluid from passing out of the bottle through the channel. Advantageously, the channel has a width smaller than about 0.005 inches. Preferably, but optionally, the method also includes fastening at least one handle to the cap so a child sucking from the nipple can hold the handle. Advantageously, the at least one handle is formed so that it extends along a length of the bottle for a distance of about ½ to ¾ of a length of the bottle. Moreover, the nipple cap preferably has an internal diameter of less than about 1.3 inches.

### BRIEF DESCRIPTION OF THE DRAWINGS

These, as well as other features of the present invention, will become more apparent upon reference to the drawing, in which like numbers refer to like parts throughout, and in wherein:

FIG. 1 is an exploded view of a nipple assembly constructed in accordance with the present invention;

FIG. 2 is a partial, cross-sectional view of the nipple assembly of FIG. 1 placed on a bottle; and

FIG. 3 is a plan side view of a further embodiment of this invention showing handles.

### DETAILED DESCRIPTION

Referring to FIG. 1, wherein the showing is for purposes of illustrating one embodiment of the present invention only, and not for purposes of limiting the same, the subject invention is directed to a nipple assembly 10 which is adapted for retrofit attachment to the externally threaded neck of a conventional water or juice bottle 11 (e.g., a sports bottle). Such conventional water or juice bottles 11 typically comprise a containment portion which has a circular cross-sectional configuration and transitions or tapers into an externally threaded neck portion of reduced diameter as compared to the diameter of the containment portion. Further, as used herein the term “bottle” includes other fluid containers not conventionally referred to as bottles, such as small, generally rectangular drink cartons or milk cartons that have a neck comprising an externally threaded spout extending from a top of the carton.

Often formed upon the neck portion immediately below the external threads is a flange portion which extends radially outward from the neck portion.

Many water and juice bottles 11 currently available in the marketplace include a “push-pull cap” which is threadably engaged to the neck portion. The push-pull cap comprises an internally threaded collar which is threadably engageable to the neck portion of the container.

Protruding axially from one side of the collar is a stem having a closure member which is movably mounted thereto. Pulling the closure member away from the collar facilitates the creation of an open flow passage which extends from the interior of the container, between the stem and the closure member, and out of the closure member via an opening formed therein. Such flow passage is effectively blocked by pushing the closure member back toward the collar.

The nipple assembly 10 of the present invention comprises an internally threaded cap 12. More particularly, the cap 12 defines a generally cylindrical outer wall 14 which is formed to include threads 16 on the inner surface thereof. As used herein, the term threads includes continuous or intermittent threads, bayonet mounts, and any other interlocking mechanisms that use relative rotation to engage locking portions on two mating parts. The threads 16, as broadly defined herein, comprise rotational locking means that are sized and configured to releasably engage the nipple cap 12 to the bottle 11 during use.

Formed on one end of the outer wall 40 is an annular, circularly configured end wall 18 having a opening 20 that is preferably, but optionally, circular and formed in the center of the end wall 18. The cap 12 is preferably fabricated from a plastic material, such as PVC or nylon. Additionally, the cap 12 is specifically sized and configured to be threadably engageable to the neck portion 21 of the conventional bottle 11, such as the water bottle 11 or juice bottle 11 described above. In this regard, the cap 12 is preferably sized and configured to generally mirror the size and configuration of the collar of the above-described push-pull cap.

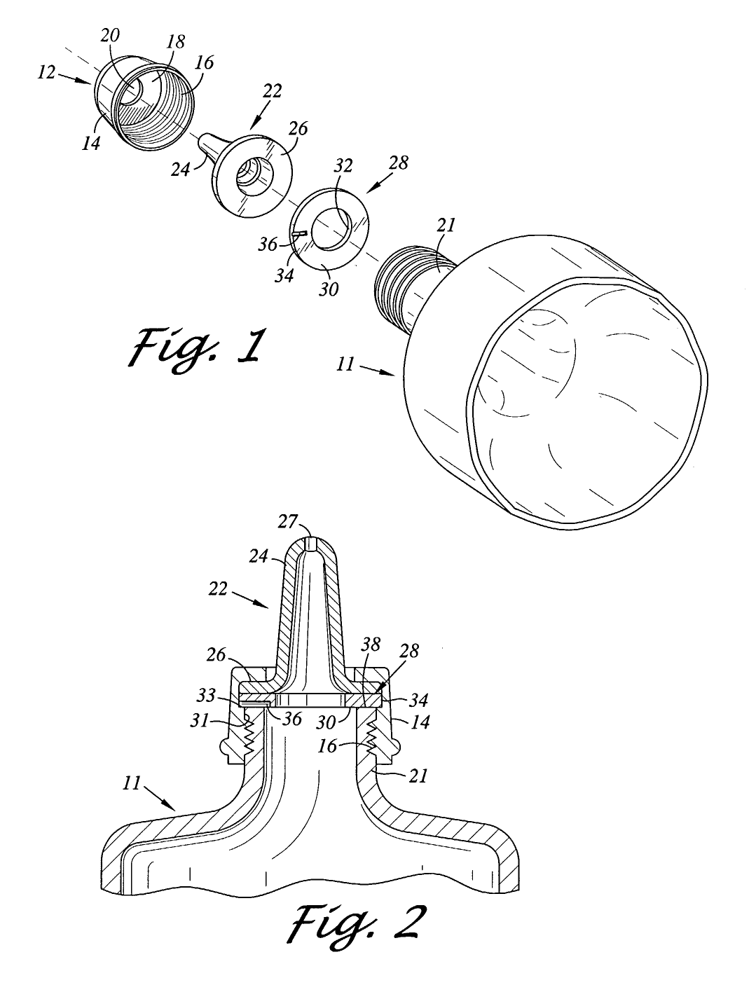

In addition to the cap 12, the nipple assembly 10 comprises a nipple 22. The nipple 22 itself includes a main body portion 24 and a circularly configured flange portion 26 which is integrally connected to and extends radially outward from one end of the main body portion 24. The nipple portion 22 is typically about ⅜ to ½ inch (about 9 mm to 13 mm) in outer diameter and about 0.5 to 2 inches (about 13 mm to 50 mm) long. As shown in FIG. 2, disposed within the rounded distal end of the main body portion 24 disposed furthest from the flange portion 26 is an outflow opening 27 which fluidly communicates with the hollow interior of the main body portion 24. The nipple 22 is preferably fabricated from a resilient material such as rubber, a polymer, or other elastomeric material.

In addition to the cap 12 and nipple 22, the nipple assembly 10 preferably, but optionally comprises an annular, circularly configured disc referred to herein as an annular disc 28 or snap ring 28. The snap ring 28 defines an inner surface, an opposed outer surface 30, an inner peripheral edge 32, and an outer peripheral edge 34. As seen best in FIG. 2, the cap 12 preferably, but optionally, has a ledge or projection 31 forming a recess 33 about the same diameter as the outer diameter of the snap ring 28 and as the flange 26 on the nipple. The snap ring 28 is slightly larger than an interior diameter of the annular walls 14 so the peripheral edge 32 snaps into and is retained by the projection or ledge 31 in the recess 33. The ledge 31 is preferably continuous and extends around the entire inner periphery of the annual walls 14, but it could be intermittent.

The snap ring 28 retains the nipple 22 in the cap 12. Other mechanisms could be used to retain the nipple 22 in lieu of, or in addition to the snap ring 28. For example, the snap ring 28 could be sonically welded, glued, or otherwise fastened to the cap 12 or to the annular walls 14. The nipple 22 could be molded integrally with the cap 12. The nipple 22 could be molded integrally with the ring 28 and the ring fastened to the cap. The nipple 22 could be adhered, staked or otherwise fastened to the cap 12 without using a ring 28. Other ways of fastening the nipple to the cap could be used. Advantageously the nipple 22 is fastened to the cap 12 in a manner that makes it difficult or impossible to remove the nipple without destroying the assembly 10, but in a less preferred embodiment the nipple could be removable from and separable from the cap.

Preferably, but optionally, there is formed within the outer surface 30 of the snap ring 28 a vent that could be a completely internal channel, but is preferably a groove or channel 36 formed in the exterior surface of ring 28 and which opens onto and extends from the outer peripheral edge 34 and toward the interior of the ring 28 a distance sufficient to pass a distal end 38 of the neck 21 of the bottle 11 to which the cap 12 is fastened during use. Preferably, but optionally, as seen in FIGS. 1 and 2, the vent channel 36 does not extend to the inner peripheral edge 32. The use of the vent channel 36 will be described in more detail below. Like the cap 12, the snap ring 28 is preferably, but optionally, fabricated from a plastic material. The outer diameter of the snap ring 28 is preferably substantially equal to the outer diameter of the flange portion 26 of the nipple 22, with such diameters being slightly less than the outer diameter of the end wall 18 of the cap 12.

The nipple assembly 10 is put together by advancing the main body portion 24 of the nipple 22 through the opening 20 disposed within the end wall 18 of the cap 12. Such advancement is continued until such time as the flange portion 26 of the nipple 22 is brought in direct, abutting contact with the inner surface of the end wall 18. As will be recognized, the opening 20 is sized to accommodate the diameter of that region of the main body portion 24 which is disposed closest to the flange portion 26.

Upon the engagement of the nipple 22 to the cap 12 in the above-described manner, the snap ring 28 is advanced into the cap 12 in a manner wherein the inner surface thereof is brought into direct, abutting contact with the exposed, outer surface of the flange portion 26. The nipple assembly 10 is thereafter threadably engageable to the neck portion 21 of the conventional water bottle 11 or juice bottle 11.

More particularly, the cap 12 is threadably engaged to the neck portion, with the rotation of the cap 12 being continued until such time as the snap ring 28 and flange portion 26 of the nipple 22 are captured and compressed between the inner surface of the end wall 18 and the distal rim or lip 38 of the neck portion 21. That helps provide a fluid seal to prevent the contents of the container or bottle 11 from leaking out. The lip 38 presses the ring 28 and flange 26 against the end wall 18 of the cap 12. The flange 26 of the nipple 22 is typically compressible and helps form a fluid-tight seal. The lip 38 pressing against the ring 28 could also form a fluid tight seal and that would result in a vacuum in the bottle 11 sufficient to collapse the nipple 22 as fluid is sucked through the outflow opening 27 in the nipple. If the nipple collapses, it is difficult to suck fluid through the outflow opening 27 and a baby will stop sucking and air will enter the outflow opening 27.

The inclusion of the vent channel 36 within the outer surface 30 of the snap ring 28 effectively vents air into the threads 16 of the cap 12 and allows air to enter the bottle 11 so as to prevent collapse of the nipple 22. The vent channel 36 also prevents creating a vacuum in the bottle 11 that would inhibit removal of the nipple assembly 10 from the water or juice bottle 11. The channel 36 is thus advantageously long enough to extend from the interior of the lip 38 to the interior of the annular walls 14 where the internal threads on the cap 12 allow air flow to the channel. There could be one, or a plurality of channels 36.

The vent channel 36 is small, preferably small enough to allow passage of air but not the fluid contained in the bottle 11. A channel 36 sized to prevent passage of water while allowing passage of smaller air molecules is preferred, even if the cap 12 will be used with fluids having a greater density and viscosity than water. A channel 36 having a width of a few thousandths of an inch is believed suitable, A width of about 0.005 inches (about 0.1 mm) or less is believed suitable, with the depth of the channel being about the same. A channel 36 having a “V” shaped cross section or a generally rectangular shaped cross section is believed suitable.

The ring 28 is advantageously, but optionally, formed of a less compressible material than the flange 26 of nipple 22. A ring 28 made of PVC or nylon is believed suitable. If the ring 28 is omitted, then the lip 38 will likely seal against the more flexible flange 26 and form a fluid tight and air tight seal, resulting in a vacuum being intermittently created as fluid is sucked out the outflow opening 27. Alternatively, the channel 36 could be formed in flange 26 if the ring 28 is omitted.

The inner diameter of the opening in the necks on which the threaded collar is formed commonly is from about 0.7 to 1 inch (18-25 mm), and the outer diameter is slightly larger, typically about 0.8 inch to 1.3 inch (about 20 mm to 33 mm). A neck with a diameter of about 0.8 inches, or smaller, is fairly common for the water bottles 11 of about one quart or one liter.

For a one pint bottle 11, a neck with an inner diameter of about 21-22 mm or about 0.8 to 0.9 inches is common. The external threads on the neck have an outer diameter of about 0.26-27 mm or about 1 to 1.1 inches, with a root thread diameter of about 0.9 inches or 24 mm.

The cap 12 would have annular walls 14 with mating internal thread and diameters sized to threadingly engage the external threads on these standard bottles 11. The flange 26 would fit within the cap 12 and thus have a diameter slightly smaller than the inner diameter of the annular walls 14 of the cap 12.

The hole 20 in the cap 12 is advantageously smaller than the root thread diameter so that the end wall abuts the flange 26. Advantageously, but optionally, the hole or opening 20 provides an annular end wall of about the same size as the flange 26 so the flange 26 can be sealed against the end wall. The nipple 22 is sized to fit through the opening 20 yet still have sufficient dimensions to be usable to feed a baby. A nipple 22 having an exterior diameter of about ½ inch or about 13 mm passing through the opening 20, is believed suitable for use with a one pint bottle 11, with slightly smaller or slightly larger diameters also believed suitable. Preferably, the nipple 22 is a conventional nipple, but has a radial flange 26 of smaller diameter and selected to fit within the cap 12. The cap 12 is, in turn, sized to fit a small water bottle 11, such as a 6 to 18 ounce water bottle 11.

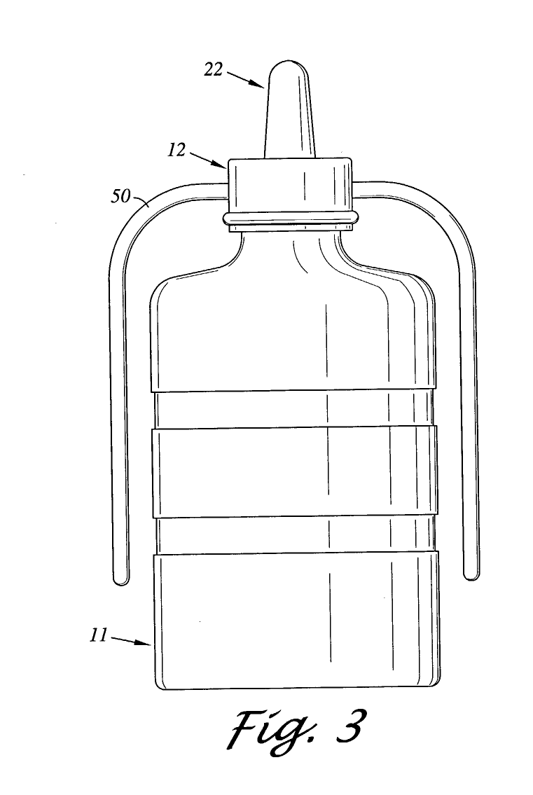

Referring to FIG. 3, in a further embodiment a handle 50 extends from the cap 12. The handle 50 preferably, but optionally, is curved so that it extends laterally from the annular walls 14 along an axis radial to a centerline of the bottle 11 and cap 12 and then curves to extend along a length of the bottle 11. Advantageously, but optionally, the handle 50 extends for about ½ to ¾ of a length of the bottle 11. That allows a child to hold the handle at about the middle of the bottle, near the center of gravity of the bottle 11. A handle 50 extending a length of about 3-5 inches (76 mm-128 mm) along the length of a 12 ounce water bottle 11 is believed suitable.

The handle 50 is advantageously thick enough so it will not break under use and abuse by a child. A handle 50 with a circular cross section is preferred, and a smooth surface to avoid abrasion. But a textured gripping surface could be provided along the gripping areas of the handle. Knurling or slightly roughened areas along the straight portions are believed suitable.

Advantageously, there are two handles 50 extending from opposing sides of the cap 11. More than two handles 50 could be formed. If four, equally spaced handles are provided, then the bottle 11 can rest on a lower two of the handles while being held by an upper two of the handles by a child. Advantageously the handles 50 are integrally molded with the cap 12, but the handles could formed separately from the cap 12 and then glued, welded, adhered or fastened to the cap. A variety of configurations for a handle 50 could be used and the depicted configuration is given for illustration, not limitation.

There is also provided a method of providing fluids to a child. Most bottle of water or fruit juice come with tamper evident caps that show whether the bottle cap has been opened and possibly tampered with. The cap, tamper-proof or otherwise, is removed from the bottle 11 and typically discarded. The bottle 11 has a tubular outlet with a distal end and external threads that threadingly engage the (tamper-evident) cap to provide a fluid tight seal over the outlet prior to removal of the (tamper-evident) cap.

After removal of the pre-existing cap, the nipple assembly 10 is fastened to the bottle 11 by threadingly engaging internal threads 16 on the nipple cap 12 to advance the end wall 18 of the nipple cap toward the bottle 11 until the distal end of the tubular outlet urges the flange 26 of nipple 22 against the end wall 18 of the nipple cap to form a fluid tight seal with the nipple cap. The body 24 of the nipple extends through the opening 20 in the nipple cap 12 to allow a child to suck fluid from the bottle and through the outflow opening 27. Advantageously, but optionally, the nipple is permanently fastened to the nipple cap to prevent separation of the nipple from the cap. Advantageously, but optionally, annular disc 28 is interposed between the distal end of the bottle outlet and the flange 26 of the nipple 22. The disc 26 is fastened to the nipple cap 12 to prevent separation of the nipple 22 from the nipple cap.

The channel 36 in the annular disc 28 extends in a direction from outer periphery 34 toward inner periphery 32, with the channel being sized to allow air or gas to pass into the bottle while preventing fluid from passing out of the bottle through the channel. The handle or handles 50 allow the child to hold the bottle near the center of gravity of the bottle while sucking fluid through the nipple 22.

Additional modifications and improvements of the present invention may also be apparent to those of ordinary skill in the art. Thus, the particular combination of parts described and illustrated herein is intended to represent only one embodiment of the present invention, and is not intended to serve as limitations of alternative devices within the spirit and scope of the invention. Further, the various features of this invention can be used alone, or in varying combinations with each other and are not intended to be limited to the specific combination described herein. Thus, the invention is not to be limited by the illustrated embodiments but is to be defined by the following claims when read in the broadest reasonable manner to preserve the validity of the claims.

I claim:

1. A nipple assembly for use with a bottle having a cylindrical neck portion with external threads and an external diameter of about 1.3 inches or less, the cylindrical portion having a distal end that defines an opening to the bottle, comprising:
a cap having an annular wall with internal threads sized to threadingly engage the threads on the bottle during use, the cap having an end wall connected to the annular wall, the end wall having a central opening therein;
a nipple having an elongated portion sized to extend through the opening, the nipple having an annular flange extending from a base of the nipple and a distal end with an outflow opening therein, the nipple being made of a flexible material and being fastened to the cap.

2. The nipple assembly of claim 1, further comprising an annular snap ring abutting the flange and cooperating with a recess in the cap to fasten the nipple to the cap.

3. The nipple assembly of claim 1, wherein the snap ring comprises a flat, annular ring having an inner and outer periphery defining a width greater than a thickness of the ring, the outer periphery cooperating with a groove in the cap to fasten the nipple to the cap.

4. The nipple assembly of claim 2, wherein the snap ring has an inner periphery and an outer periphery defining a width between the inner and outer peripheries, and at least one channel extending from the outer periphery toward the inner periphery a distance sufficient to extend past the distal end defining the opening of the bottle when the cap is placed on the bottle during use, the channel being sized to allow passage of air into the bottle but not allow water to pass out of the bottle when the cap is placed on the bottle.

5. The nipple assembly of claim 4, wherein the channel does not extend to the inner periphery.

6. The nipple assembly of claim 2, further comprising at least one handle extending from the cap a distance sufficient for a child to grab the handle while sucking on the nipple during use of the assembly.

7. The nipple assembly of claim 5, further comprising at least one handle extending from the cap a distance sufficient for a child to grab the handle while sucking on the nipple during use of the assembly.

8. The nipple assembly of claim 2, further comprising at least one handle extending from the cap and along a length of the bottle corresponding to about ½ to ¾ the length of the bottle.

9. The nipple assembly of claim 5, further comprising at least one handle extending from the cap and along a length of the bottle corresponding to about ½ to ¾ the length of the bottle.

10. A nipple assembly for use with a bottle having a cylindrical portion with an external diameter between about ½ and 1 and ⅓ inches or less, the cylindrical portion having a distal end defining an opening to the bottle, comprising:
a cap having rotational locking means sized and configured to releasably engage the threads on the bottle during use, the cap having a opening with a nipple extending through the opening, the nipple being made of a flexible material and being fastened to the cap.

11. The nipple assembly of claims 10, wherein the nipple comprises a flange larger than the opening, the flange having a first surface abutting the cap and an opposing, second surface abutting a flat disc having an inner and outer periphery defining a width, the width being large enough to engage the distal end defining the opening of the bottle during use.

12. The nipple assembly of claim 11, wherein the outer periphery cooperates with a ledge on the cap to permanently fasten the nipple to the cap.

13. The nipple assembly of claim 11, further comprising a channel extending across at least a portion of the width from the outer periphery toward the inner periphery, the channel having a width of about 0.005 inches or less.

14. The nipple assembly of claim 11, further comprising handle means fastened to the cap for holding the cap and bottle during use.

15. The nipple assembly of claim 11, further comprising a bottle having a cylindrical portion with external threads that are releasably engaged with the rotational locking means.

16. A nipple assembly, comprising:
a nipple having a flange extending from a base of the nipple, the flange having a maximum dimension of less than about 1.3 inches, the nipple having a body portion extending from the flange and having an outflow opening in a distal end of the body portion;
a cap having an opening therein through which the body portion extends, the flange abutting an end wall of the cap, the cap having side walls sized to accommodate the flange internal to the cap with internal threads being formed on the side walls, the nipple being fastened to the cap to prevent separation of the cap and nipple; and
a bottle having a tubular, cylindrical portion with external threads and defining an opening to the bottle, a distal end of the cylindrical portion urging the flange against the end wall when the external threads threadingly engage the internal threads a sufficient amount.

17. The nipple assembly of claim 16, further comprising an annular disc interposed between the distal end of the cylindrical portion and the flange of the nipple.

18. The nipple assembly of claim 16, wherein the annular disc is fastened to the cap to prevent removal of the nipple from the cap.

19. The nipple assembly of claim 17, further comprising at least one handle fastened to the cap.

20. The nipple assembly of claim 19, wherein there are two handles, each extending along a length of the bottle a distance of about ½ to ¾ of a length of the bottle.

21. The nipple assembly of claim 19, wherein the handle is integrally molded with the cap.

22. The nipple assembly of claim 16, wherein the bottle comprises a bottle of water purchased full and with a sealed cap which sealed cap is removed and discarded so the nipple assembly can be fastened to the bottle.

23. The nipple assembly of claim 17, further comprising a channel formed on a side of the disc facing the bottle, the channel being sized to place the interior of the bottle in gaseous communication with the threads on the side walls but to prevent liquid from flowing from the bottle and through the channel during use of the nipple assembly.

24. A method of providing fluids to a child, comprising:
removing a tamper-evident cap from a bottle of fluid, the bottle having a tubular outlet with a distal end and external threads that threadingly engage the tamper-evident cap to provide a fluid tight seal over the outlet prior to removal of the tamper-evident cap;
fastening a nipple assembly to the bottle by threadingly engaging internal threads on a nipple cap to advance an end wall of the nipple cap toward the bottle until the distal end of the tubular outlet urges a flange of a nipple toward the end wall of the nipple cap an amount sufficient to form a fluid tight seal with the nipple cap, the nipple extending through an opening in the nipple cap and having a outflow opening in a distal end of the nipple to allow the child to suck fluid from the bottle and through the outflow opening.

25. The method of claim 24, further comprising fastening the nipple to the nipple cap to prevent separation of the nipple from the cap.

26. The method of claim 24, further comprising interposing an annular disc between the distal end of the outlet and the flange of the nipple and fastening the disc to the nipple cap to prevent separation of the nipple from the nipple cap.

27. The method of claim 26, further comprising forming a channel in the annular disc, the channel extending in a direction from an outer periphery toward an inner periphery of the disc, the channel being sized to allow air to pass into the bottle while preventing fluid from passing out of the bottle through the channel.

28. The method of claim 26, wherein the channel has a width smaller than about 0.005 inches.

29. The method of claim 26, further comprising fastening at least one handle to the cap so a child sucking from the nipple can hold the handle.

30. The method of claim 26, further comprising forming the at least one handle so that it extends along a length of the bottle for a distance of about ½ to ¾ of a length of the bottle.

31. The method of claim 26, wherein the nipple cap has an internal diameter of less than about 1.3 inches.

32. The method of claim 26, wherein the bottle comprises a bottle of water.

33. The method of claim 26, wherein the bottle comprises a carton of fruit juice.

34. A method of providing fluids to a child, comprising:
removing a first cap from a bottle of fluid, the bottle having a tubular outlet with a distal end and external threads that threadingly engage the first cap to provide a fluid tight seal over the outlet prior to removal of the first cap, the first cap having an internal diameter of less than about one and ⅓ inches;
fastening a nipple assembly to the bottle by threadingly engaging internal threads on a nipple cap to advance an end wall of the nipple cap toward the bottle until the distal end of the tubular outlet urges a flange of a nipple toward the end wall of the nipple cap and forms a fluid tight seal with the nipple cap, the nipple extending through an opening in the nipple cap and having a outflow opening in a distal end of the nipple to allow the child to suck fluid from the bottle and through the outflow opening, the nipple being fastened to the nipple cap to prevent separation of the nipple from the cap.

35. The method of claim 34, further comprising interposing an annular disc between the distal end of the outlet and the flange of the nipple and fastening the disc to the nipple cap to prevent separation of the nipple from the nipple cap.

36. The method of claim 35, further comprising forming a channel in the annular disc, the channel extending in a direction from an outer periphery toward an inner periphery of the disc, the channel being sized to allow air to pass into the bottle while preventing fluid from passing out of the bottle through the channel.

37. The method of claim 36, wherein the channel has a width smaller than about 0.005 inches.
